(19) United States
(12) Patent Application Publication
(10) Pub. No.: US 2004/0104976 A1
(43) Pub. Date: Jun. 3, 2004

(54) Pressure chamber of a piezoelectric ink jet print head and fabrication method thereof

(76) Inventor: Chen-Hua Lin, Douliou City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/696,350

(22) Filed: Oct. 29, 2003

(30) Foreign Application Priority Data
Dec. 3, 2002 (TW) 91135056

(51) Int. Cl. B41J 2/045

(52) U.S. Cl. 347/68

(57) ABSTRACT

A pressure chamber of a piezoelectric ink jet print head and a fabrication method thereof. The pressure chamber comprises a substrate, a concave chamber formed on the substrate, having an opening of a relatively large sectional area and a bottom of a relatively small sectional area, a vibrating plate formed above the concave chamber, and a piezoelectric unit on the vibrating plate.

### BACKGROUND OF THE INVENTION

1. Field of the Invention

The invention relates to a pressure chamber of a piezoelectric ink jet print head and a fabrication method thereof, and more particularly to a pressure chamber whereby the pressure applied by a piezoelectric unit is concentrated on ink near the print head.

2. Description of the Related Art

A piezoelectric ink jet print head employs a forced voltage to deform a piezoelectric ceramic body, and uses flexure displacement of the piezoelectric ceramic body to change the volume of a pressure chamber, thus the chamber expels an ink droplet. Since high-temperature gasification is omitted and the piezoelectric ceramic body has quick response and no thermal conductivity restrictions, the piezoelectric ink jet print head has the advantages of superior durability, high-speed print performance, and superior print quality. The piezoelectric ink jet print head has been commercialized into a bend mode and a push mode according to the deformation mechanism of the piezoelectric body. Generally, the bend mode uses a face-shooter piezoelectric deformation, and the push mode uses an edge-shooter piezoelectric deformation.

FIG. 1 is a cross-section illustrating the conventional bend mode of a piezoelectric ink jet print head. The piezoelectric ink jet print head comprises a piezoelectric ceramic body 10, a vibrating plate 11, a pressure chamber 12, an inlet hole 13, a manifold 14 and a nozzle orifice 15. When a voltage is exerted by a control circuit 16, the piezoelectric ceramic body 10 is deformed and impeded by the vibrating plate 11 causing it to bend laterally, thus extruding ink in the pressure chamber 12. As the voltage difference arises between the internal space and the external circumference, the ink adjacent to the nozzle orifice 15 is accelerated and expelled as an ink droplet.

Conventionally, the vibrating plate and the pressure chamber are formed by a laminated ceramic co-fired method which includes steps of synthesizing raw powders (such as PZT, ZrO₂, PbO, TiO₂ and other additives), by mixing, drying, calcining, smashing, granulating, squeezing, shaping, sintering and polarizing. This complicated and difficult procedure of the laminated ceramic co-fired method, however, has disadvantages of low yield and high cost and is unfavorable to mass production. Accordingly, a modified etching process for forming the pressure chamber and increasing process reliability thereof is called for.

Currently, in semiconductor etching processing, many approaches to a deep-hole etching technique have been developed and successfully applied to micro electro-mechanical structures. The deep-hole etching technique, such as a wet etching method through a chemical reaction or a dry etching process through a physical reaction, however, has the drawbacks of directional etching result, low etching rate and excessive process costs.

A fabrication method of a pressure chamber, involving etching a silicon substrate to directly form a pressure chamber, has been disclosed in R.O.C. Patent No. 420638 with steps as described below.

FIGS. 2a-2f are cross-sections showing the fabrication of the pressure chambers. In FIG. 2a, a silicon substrate 20 is provided with thermal oxide films 22 on its upper and lower surface. A common electrode 23, a piezoelectric body 24, and an upper electrode 25 are then sequentially formed on the upper thermal oxide film 22.

In FIG. 2b, a photoresist 26 is then disposed on the upper electrode 25, and patterned according to a predetermined pattern by photolithography.

In FIG. 2c, the upper electrode 25 and piezoelectric body 24 are etched using the patterned photoresist 26 as a mask. The patterned photoresist 26 is then peeled and a piezoelectric unit 27 is completed.

In FIG. 2d, a photoresist layer 28 is formed on the counter side of the silicon substrate 20, and patterned according to a predetermined pattern by photolithography.

In FIG. 2e, the thermal oxide layer 22 and the silicon substrate 20 are wet-etched using the patterned photoresist 28 as a mask. The patterned photoresist 28 is then peeled and a pressure chamber 29 is completed.

In FIG. 2f, a nozzle plate 31 with a nozzle orifice 30 is bonded on the silicon substrate 20 corresponding to the pressure chamber 29 to form an ink jet print head.

In the above method, the wet etching is convenient and inexpensive. However, for a [100] silicon substrate, the etched area of a pressure chamber 29 decreases as wet etching approaches, resulting in a relatively large sectional area near the nozzle orifice 30 and a relatively small sectional area in the bottom of the pressure chamber 29. Owing to the relatively large sectional area near the nozzle orifice 30 of the pressure chamber 29, the distance between each nozzle orifice must be extended, which is unfavorable to high-resolution ink-jet printing.

Another disadvantage suffered is the lack of efficiency in transferring the pressure applied by the piezoelectric unit 27 via the bottom part of a smaller sectional area to the top part of a greater sectional area.

Applying a silicon substrate with a specific crystal structure, for example, [110], may ameliorate the above disadvantages, but a pressure chamber with a uniform sectional area still cannot be obtained. Applying dry etching may eliminate the disadvantages, but increases cost by 20-30 times.

### SUMMARY OF THE INVENTION

Accordingly, an object of the present invention is to provide a pressure chamber of a piezoelectric ink jet print head and the fabrication method thereof, whereby the pressure applied by the piezoelectric unit is concentrated on the ink near the orifice, the manufacturing cost is lowered, and the density of the nozzle orifice pattern is increased.

The invention provides a pressure chamber of a piezoelectric ink jet print head, which comprises a substrate, a concave chamber formed on the substrate, having an opening with a relatively large sectional area and a bottom with a relatively small sectional area, a vibrating plate formed above the concave chamber, and a piezoelectric unit on the vibrating plate.

The invention also provides a fabrication method for a pressure chamber of a piezoelectric ink jet print head, which comprises steps of providing a substrate, forming a concave chamber on the substrate to serve as the pressure chamber, wherein the concave chamber has an opening of a relatively large sectional area and a bottom of a relatively small sectional area, forming a vibrating plate above the concave chamber, and forming a piezoelectric unit on the vibrating plate.

According to the invention, the pressure chamber has a cross-section of various sizes in the thickness direction, wherein the cross-section near the piezoelectric unit is relatively large, and the cross-section near the nozzle orifice is relatively small. Owing to the decreasing cross-sectional area of the pressure chamber from the piezoelectric unit side to the nozzle orifice side, the pressure given by the piezoelectric unit is effectively concentrated and amplified via the pressure chamber, applying a more powerful pressure on the ink near the nozzle orifice.

Because the pressure is efficiently transferred and amplified, the cross-sectional area may be reduced, the density of nozzle orifice pattern may be increased, and the resolution may be enhanced.

In addition, the provided fabrication method may apply wet etching to form the pressure chamber, which is easily performed and relatively inexpensive.

### DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section illustrating a conventional bend mode of the piezoelectric ink jet print head.

FIGS. 2a to 2f are cross-sections illustrating a conventional fabrication method for a pressure chamber of a piezoelectric ink jet print head.

FIGS. 3a to 3d are cross-sections illustrating a fabrication method for a pressure chamber of a piezoelectric ink jet print head according to the embodiment of the present invention.

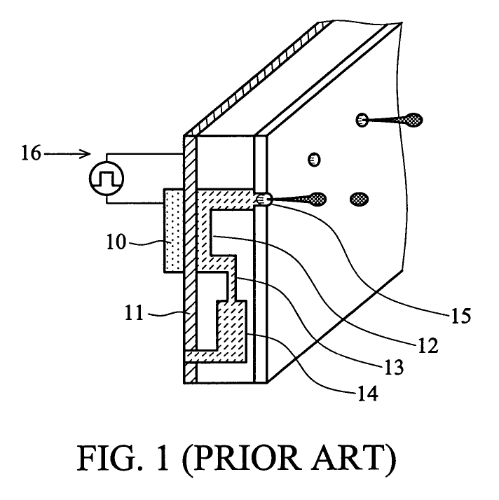

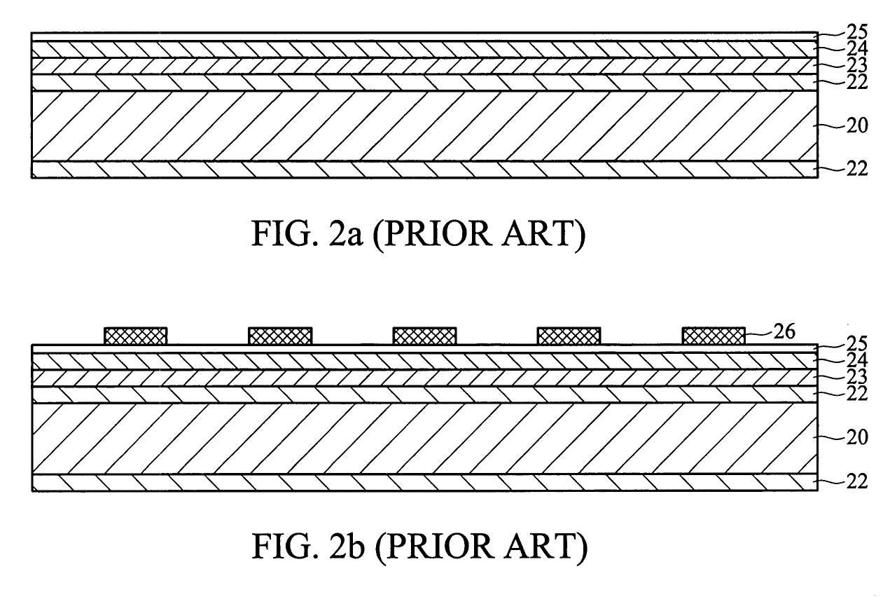

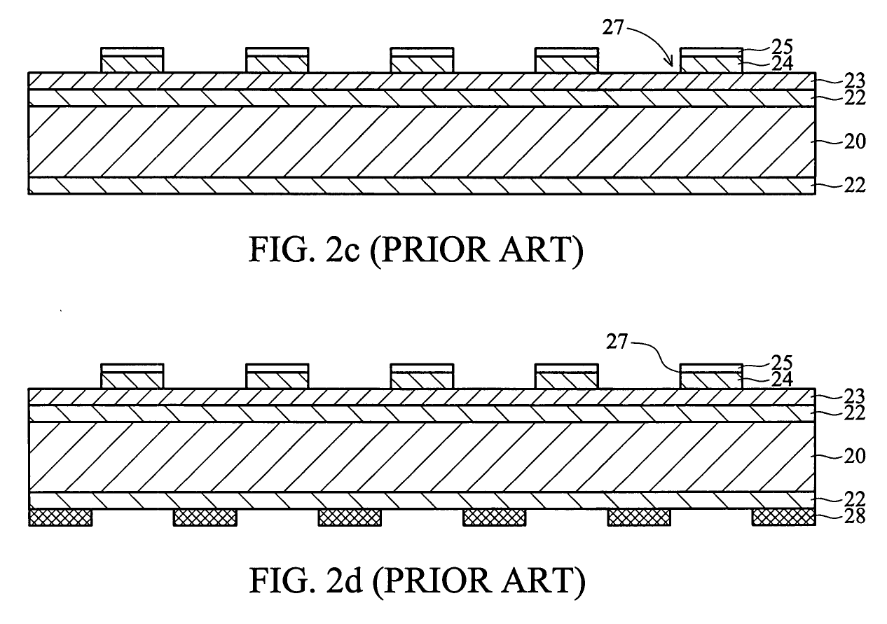

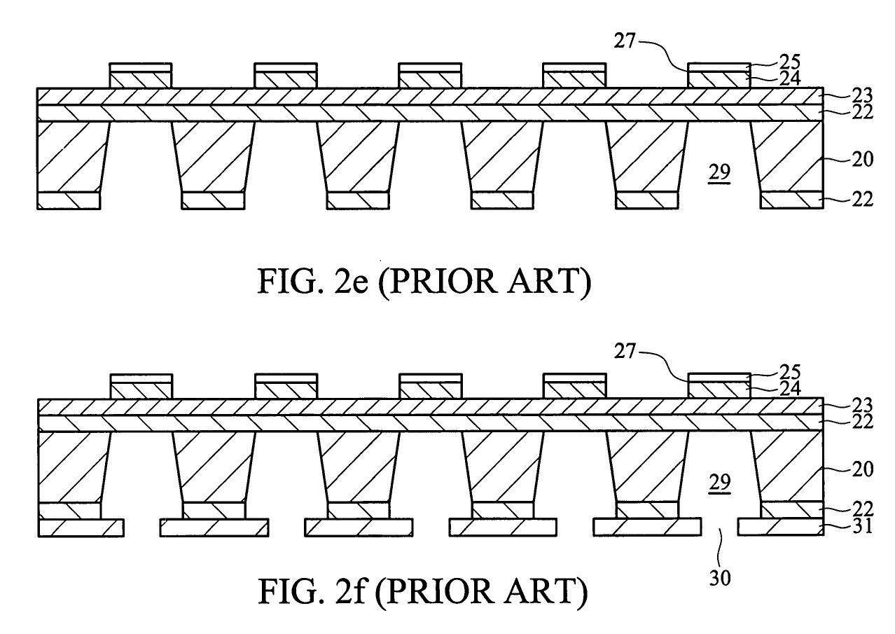

### DETAILED DESCRIPTION OF THE INVENTION

The present invention provides a pressure chamber of a piezoelectric ink jet print head and a fabrication method thereof, whereby the pressure applied by a piezoelectric unit is concentrated and amplified via the chamber to a nozzle orifice, lowering the manufacturing cost and increasing the density of nozzle orifice pattern. In the following embodiment, the amount, arrangement, and size of the nozzle orifices are design choices and not limited to this. Moreover, the ink chamber may be fabricated before or after the pressure chamber.

Embodiment

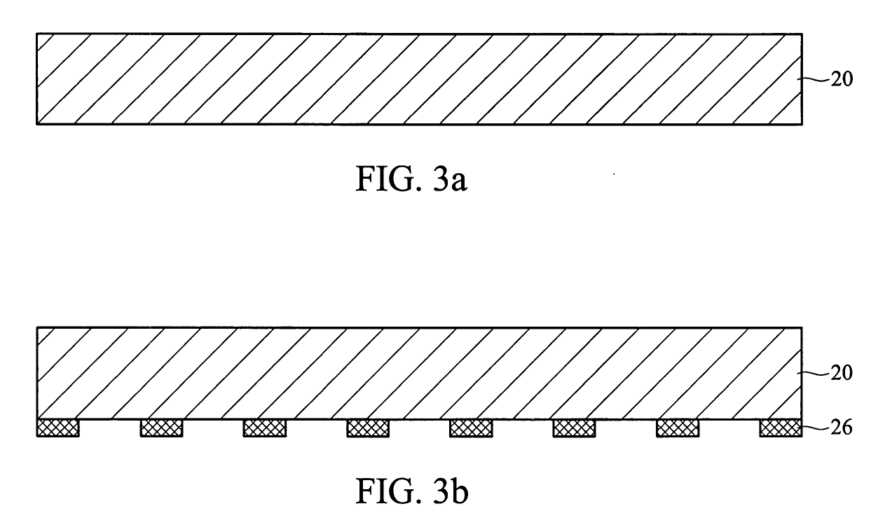

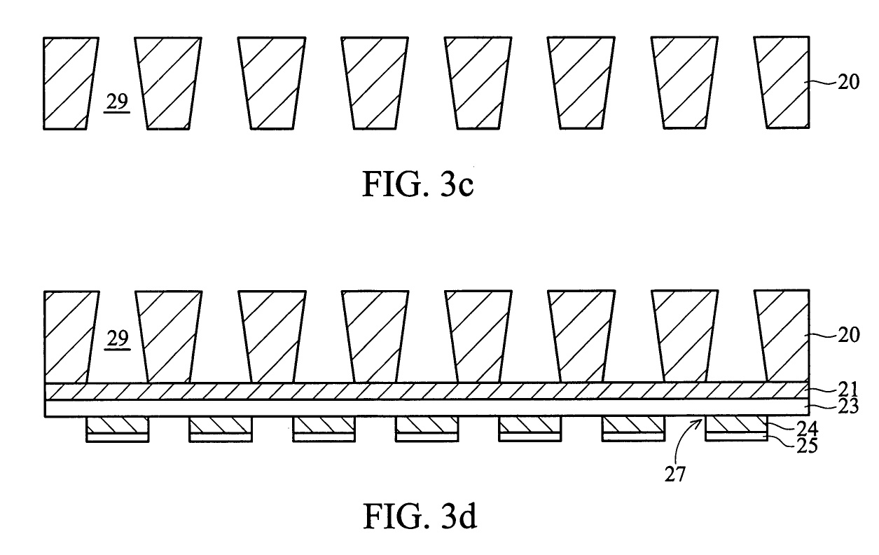

FIGS. 3a to 3d are cross-sections illustrating a fabrication method for a pressure chamber of a piezoelectric ink jet print head according to the embodiment of the present invention.

In FIG. 3a, a silicon substrate 20, for example a silicon wafer, having a crystal structure of [100] or [110] is provided.

In FIG. 3b, a photoresist layer 26 is formed on the lower surface of the silicon substrate 20, and then patterned according to a predetermined pattern.

In FIG. 3c, using the patterned photoresist layer 26 as a mask, the silicon substrate 20 is through-hole etched by wet etching. The photoresist layer 26 is then peeled away, leaving a plurality of pressure chambers 29 on the silicon substrate 20. Because of the crystal structure [100] of the silicon substrate 20, the etched chamber has a relatively large sectional area near the opening of the chamber, and a relatively small sectional area near the bottom of the chamber.

In FIG. 3d, a vibrating plate 21 is bonded on the lower surface of the silicon substrate 20. The vibrating plate 21 can be a silicon wafer, a metal plate or a ceramic plate. In the embodiment, a silicon wafer is employed as the vibrating plate 21. The silicon wafer 21 is bonded with the silicon substrate 20 under a high temperature and a high pressure. For example, a solvent having hydrogen bonds is coated on the silicon substrate 20 to help fix its relative position after bonding. Pressure is then applied to bond the silicon substrate 20 and the vibrating plate 21. Additionally, adhesives can also be applied to bond the silicon substrate 20 and the vibrating plate 21. The adhesives are preferably inorganic adhesives such as borosilicate glass or phosphosilicate glass capable of enduring high sintering temperature.

Finally, the thickness of the silicon wafer 21 is reduced to about 5-20 μm to serve as the vibrating plate. A piezoelectric unit 27 is then formed, corresponding to the pressure chamber 29, by sequentially forming a common electrode 23, a piezoelectric body 24 and upper electrodes 25 on the vibrating plate 21. The piezoelectric body is made of, for example, lead zirconate titanate, and the piezoelectric unit 27 is completed by co-firing.

Compared to a conventional pressure chamber of a piezoelectric ink jet print head, the inventive pressure chamber has a cross-section of various sizes in the thickness direction, wherein the cross-section near the piezoelectric unit is relatively large, and the cross-section near the nozzle orifice is relatively small. Owing to the decreased cross-sectional area of the pressure chamber from the piezoelectric unit side to the nozzle orifice side, the pressure provided by the piezoelectric unit is effectively concentrated and amplified via the pressure chamber, applying a more powerful pressure on the ink near the nozzle orifice.

Because the pressure is efficiently transferred and amplified, the cross-sectional area can be reduced, the density of nozzle orifice pattern can be increased, and the resolution can be upgraded.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pressure chamber of a piezoelectric ink jet print head, comprising:
a substrate;
a concave chamber formed on the substrate, having an opening of a relatively large sectional area and a bottom of a relatively small sectional area;
a vibrating plate formed above the concave chamber; and
a piezoelectric unit on the vibrating plate.

2. The pressure chamber as claimed in claim 1, wherein the substrate is a silicon substrate.

3. The pressure chamber as claimed in claim 2, wherein the substrate is a silicon wafer with a crystal structure of [100] or [110].

4. The pressure chamber as claimed in claim 2, wherein the concave chamber is formed by wet etching.

5. The pressure chamber as claimed in claim 1, wherein the cross-section of the concave chamber is rectangular.

6. The pressure chamber as claimed in claim 1, wherein the vibrating plate is a silicon wafer, a metal plate or a ceramic plate.

7. The pressure chamber as claimed in claim 1, wherein the vibrating plate is formed above the concave chamber by wafer-bonding.

8. The pressure chamber as claimed in claim 1, wherein the piezoelectric unit comprises lead zirconate titanate (PZT).

9. A fabrication method for a pressure chamber of a piezoelectric ink jet print head, comprising steps of:
providing a substrate;
forming a concave chamber on the substrate to serve as the pressure chamber, wherein the concave chamber has an opening of a relatively large sectional area and a bottom of a relatively small sectional area;
forming a vibrating plate above the concave chamber; and
forming a piezoelectric unit on the vibrating plate.

10. The fabrication method for a pressure chamber as claimed in claim 9, wherein the substrate is a silicon substrate.

11. The fabrication method for a pressure chamber as claimed in claim 10, wherein the substrate is a silicon wafer with a crystal structure of [100] or [110].

12. The fabrication method for a pressure chamber as claimed in claim 10, wherein the concave chamber is formed by wet etching.

13. The fabrication method for a pressure chamber as claimed in claim 9, wherein the cross-section of the concave chamber is rectangular.

14. The fabrication method for a pressure chamber as claimed in claim 9, wherein the vibrating plate is a silicon wafer, a metal plate or a ceramic plate.

15. The fabrication method for a pressure chamber as claimed in claim 9, wherein the vibrating plate is formed above the concave chamber by wafer-bonding.

16. The fabrication method for a pressure chamber as claimed in claim 9, wherein the piezoelectric unit comprises lead zirconate titanate (PZT).
